(19) United States
(12) Patent Application Publication
(10) Pub. No.: US 2010/0045892 A1
(43) Pub. Date: Feb. 25, 2010

(54) LIQUID CRYSTAL DISPLAY DEVICE ADAPTED FOR CONVENIENT AND QUICK MAINTENANCE

(75) Inventor: Chung-Ming Hu, Taipei City (TW)

Correspondence Address: WPAT, PC;INTELLECTUAL PROPERTY ATTORNEYS, 2030 MAIN STREET, SUITE 1300, IRVINE, CA, 92614, US

(73) Assignee: Oripix Company Limited, Taipei City (TW)

(21) Appl. No.: 12/545,314

(22) Filed: Aug. 21, 2009

(30) Foreign Application Priority Data
Aug. 22, 2008 (TW) 097132251

(51) Int. Cl. G02F 1/1333

(52) U.S. Cl. 349/58

(57) ABSTRACT

A liquid crystal display (LCD) device is provided. The LCD device is adapted to be conveniently and quickly maintained. The LCD device includes a fixed mount and a movable mount which are rotatably or movably connected with each other. The movable mount is positioned in front of the fixed mount. An LCD module including a backlight source, an LCD panel, and an optical film stack is accommodated in an inner space defined by the fixed mount and/or the movable mount. After using a period of time, the backlight source or the optical film stack of the liquid crystal display device may need to be replaced due to damage. At that time, it is only needed to open the movable mount, so as to conveniently proceed with the disassembly and replacement of the elements of the liquid crystal display.

### BACKGROUND OF THE INVENTION

1. Field of the Invention

The present invention relates generally to a liquid crystal display (LCD) device, and more particularly, to an LCD device adapted for being installed in public places.

2. The Prior Arts

Currently, digital signages are highly demanded for commercial purpose. For example, in a shopping mall, department store, airport, or subway station, there are often many electronic boards installed for continuously displaying dynamic images for broadcasting advertisement or information. Such electronic boards can be divided into two kinds. One typical electronic board is constituted of a plurality of LEDs arranged in a matrix, and another typical electronic board is characterized in that it employs a plasma display panel (PDP) or an LCD for outputting images. Generally, the resolution of the images displayed by the LED type digital board is usually unsatisfactory, and a PDP is usually expensive and has a short lifespan. As such, LCDs are typically believed the better choice for serving as electronic boards.

Conventionally, an LCD device typically includes an LCD panel, an optical film stack, a backlight module, and a reflective sheet sequentially stacked one on another. The optical film stack is constituted of a brightness enhance film (BEF), a diffuser sheet, and a prism sheet. The backlight module can be alternatively provided with a light guide plate (LGP) or a direct type backlight source in accordance with the practical application. Generally, in public places, electronic boards are often required to provide higher luminance, and therefore the LCD type electronic boards usually adopt direct type backlight sources constituted of a plurality of lamps, or adopt a backlight module constituted of multiple light sources.

However, the image quality of such an electronic product may be degraded by a long period operation, while at the same time the luminance may attenuate and the life of the digital board may even terminate. The degrading of the image quality is usually caused by a decrease of light transmittance due to the aging or yellowing of the optical film stack. The attenuation of the luminance is often caused by the expiration of the lifespan of the light source elements. In addition, damages of electronic or structural components may also adversely affect the lifespan of the LCD device. As such, an LCD type electronic board is usually required for routine maintenance, in which damaged parts should be changed in time. Conventionally, the maintenance is a complicated job. Typically, a maintenance staff must go to take off the whole LCD device, and carry the LCD device back to the work site for maintenance. After that, the maintenance staff has to carry the LCD device back to where it is previously installed for installment. As such, the maintenance takes a long time, during which the electronic board does not work, which cause losses of both of the advertisement client and the advertiser.

U.S. patent publication No. 2006/0,066,767A1 discloses a maintenance mechanism adapted for replacing a single lamp tube or a detachable light source module thereof. According to the maintenance mechanism, the lamp tubes are designed to be detachable, so that when any one of the lamp tubes of the LCD device is damaged, the damaged lamp tube can be removed and replaced. However, such a design is restricted by the configuration of the outer case of the display. When the maintenance mechanism is applied in a conventional ordinary display case, the display case must be opened prior to replacing the damaged lamp tube. In many circumstances, the LCD devices of electronic boards are hung at a high position or embedded in the wall. Therefore, the maintenance of LCD device of an electronic board would have been more difficult.

### SUMMARY OF THE INVENTION

A primary objective of the present invention is to provide a better way for maintaining the LCD electronic board and replacing spare parts thereof.

Accordingly, the present invention provides an LCD device adapted for an electronic board. The LCD device is openable from a front side thereof, thus allowing maintenance staff to conveniently replace a damaged or degraded lamp tube or backlight module. Further, such an LCD device also allows to conveniently take off an aged or yellowed optical film stack having a decreased light transmittance for replacement. In such a way, the luminance of the LCD device may be recovered to the level approximate to a new device. As such, the present invention allows to conveniently recover the luminance of the LCD device, rather than to buy a new one. Further, when the LCD device is opened from the front side, other electronic parts or wires can also be changed without taking off the whole device.

The present invention can be adapted for maintaining an LCD device including a single LCD panel. Any of the backlight module, optical film stack, or electronic components, or spare parts can be conveniently replaced without disassemble the LCD device from where it is fixed. Therefore, even when the LCD device is installed at a high position or embedded in a wall, it still can be conveniently maintained.

Further the present invention can also be adapted for maintaining a large area LCD device constituted of a plurality of LCD panels. Such a large area LCD device can be assembled to a fixed mount and/or a movable mount for substituting a conventional advertising light box. In accordance with the present invention, the large area LCD device can also be conveniently maintained without taking off the LCD device from a fixed rack.

According to an embodiment of the present invention, an LCD device is provided. The LCD device includes a body constituted of a fixed mount and a movable mount. At one side of the body, the fixed mount and the movable mount are jointly coupled with each other by a hinge, a pivot, or any rotatable or movable connecting unit so that the movable mount is rotatable or movable relative to the fixed mount. The movable mount is disposed in front of the fixed mount, so that the movable mount is allowed to be opened or closed relative to the fixed mount. According to an embodiment of the present invention, a backlight source is disposed inside the fixed mount, and the movable mount includes an LCD panel, and an optical film stack sequentially disposed from the front side to the rear side. Or alternatively, according to another embodiment of the present invention, an LCD module including an LCD panel, an optical film stack and a backlight source is disposed at a suitable position inside an inner space of the fixed mount or the movable mount. When the LCD device is operated for a certain period and the backlight source or the optical film stack needs to be replaced, the LCD device can be opened from the front side for replacing the backlight source or the optical film stack, or even taking off the LCD device for maintenance. Further, according to an aspect of the embodiment, the backlight source is fixed inside the fixed mount. According to a further aspect of the embodiment, the backlight source is secured to a substrate, and the substrate is pivotally coupled inside the fixed mount. According to a still further aspect of the embodiment, the backlight source, the LCD panel and the optical film stack are together assembled to the movable mount.

According to a further embodiment of the present invention, the fixed mount and the movable mount are jointly coupled each other by a hinge or a pivot at a bottom side of the body of the LCD device. In addition, at least one additional connecting component is employed for providing a further connection between the fixed mount and the movable mount. In such a way, when the LCD device needs to be maintained, the maintenance staff can open the movable mount on site, and conveniently disassemble and replace the backlight source or the optical film stack, during which the connecting component can be used to secure the movable mount in a stable condition. The connecting component for example is a cord, or a connecting rod, or any multi-section positioning structure. The backlight source for example can be assembled inside the fixed mount or the movable mount. Further, according to an aspect of the embodiment, the backlight source is fixed inside the fixed mount or the movable mount. According to a further aspect of the embodiment, the backlight source is secured to a substrate, and the substrate is pivotally coupled inside the fixed mount. According to a still further aspect of the embodiment, the backlight source, the LCD panel and the optical film stack are together assembled to the movable mount.

Furthermore, according to an embodiment of the present invention, the fixed mount and the movable mount are jointly coupled each other by a hinge at a top side of the body of the tiled LCD device constituted of a plurality of panels. In addition, at least one additional connecting component is employed for providing a further connection between the fixed mount and the movable mount at least one side of the fixed mount or movable mount. When the LCD device is to be maintained, the connecting component can be used for maintaining the movable mount in a stable condition for providing more convenience for maintenance.

Moreover, according to an embodiment of the present invention, an LCD device includes a fixed mount and a movable mount. A set of guide rail and guide slot are respectively provided at corresponding surfaces of the fixed mount and the movable mount, respectively. The guide rail and guide slot are disposed in a vertical direction or a horizontal direction relative to the corresponding surfaces, so that the movable mount is allowed to slidably movable relative to the fixed mount along the guide slot. In such a way, when the LCD device is to be maintained, the maintenance staff can slide the movable mount away from the fixed mount, and then conveniently disassemble and replace the backlight source or the optical film stack.

According to an aspect of the embodiment, a connecting rod set is provided at least one side of the fixed mount and the movable mount for providing an additional connection therebetween during the maintenance of the LCD device.

### BRIEF DESCRIPTION OF THE DRAWINGS

The present invention will be apparent to those skilled in the art by reading the following detailed description of a preferred embodiment thereof, with reference to the attached drawings, in which:

FIG. 1 illustrates a display device according to a first embodiment of the present invention, the display device having a movable mount and a fixed mount jointly connected with a hinge at one side of the display device, and the movable mount being closed to the fixed mount;

FIG. 2 illustrates the display device of FIG. 1, in which the movable mount is opened from the fixed mount;

FIG. 3 illustrates a display device according to a second embodiment of the present invention, in which a movable mount and a substrate are shown as being rotated to open from the fixed mount;

FIG. 4 illustrates a third embodiment of the present invention, in which an LCD module is assembled in the movable mount;

FIG. 5 illustrates a display device according to a fourth embodiment of the present invention, in which the movable mount and the fixed mount are jointly coupled with each other by a hinge at a bottom side of the display device, and the movable mount is closed to the fixed mount;

FIG. 6 is a schematic diagram illustrating that the movable mount is opened from the fixed mount;

FIG. 7 illustrates a display device according to a fifth embodiment of the present invention, in which the movable mount and the substrate are opened from the fixed mount;

FIG. 8 illustrates a display device according to a sixth embodiment of the present invention, in which a long side of the movable mount is movably coupled with a long side of the fixed mount, and when the movable mount is opened from the fixed mount, a connecting rod is used for supporting the movable mount;

FIG. 9 illustrates a display device according to a seventh embodiment of the present invention, in which the movable mount and the fixed mount are vertically equipped with a set of guide rail and guide slot, respectively, so as to allow the movable mount to slide relative to the fixed mount along the guide slot;

FIG. 10 illustrates a display device according to an eighth embodiment of the present invention, in which the movable mount and the fixed mount are horizontally equipped with a set of guide rail and guide slot, respectively, so as to allow the movable mount to slide relative to the fixed mount along the guide slot; and

FIG. 11 illustrates a display device according to a ninth embodiment of the present invention, in which a connecting rod set is provided at least one side of the fixed mount and the movable mount for allowing the movable mount to be opened or closed relative to the fixed mount thereby.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

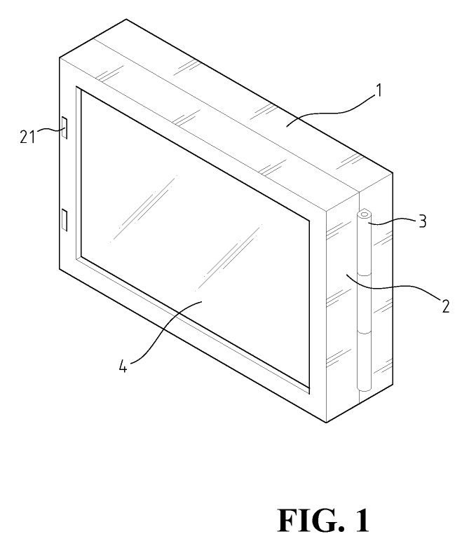

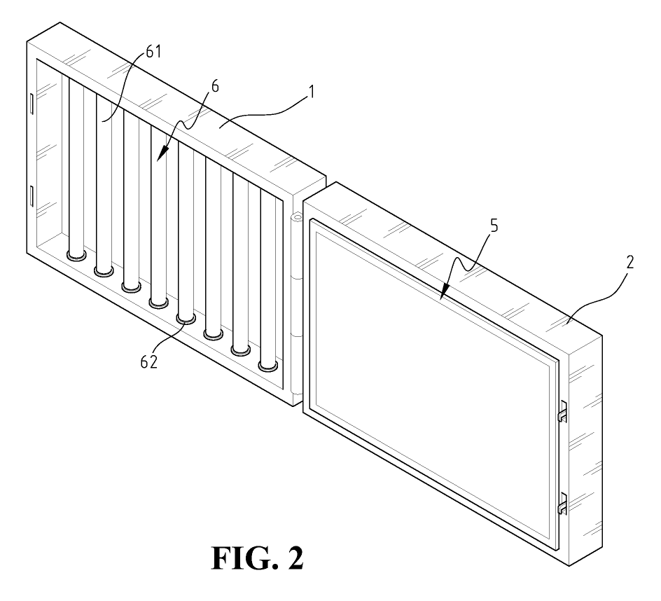

It should be noted that the following embodiment to be illustrated in more details below can be applied to a display device constituted of a single one or a plurality of LCD panels. FIG. 1 illustrates a display device according to a first embodiment of the present invention, the display device having a movable mount and a fixed mount jointly connected with a hinge at one side of the display device, and the movable mount being closed to the fixed mount. FIG. 2 illustrates the display device of FIG. 1, in which the movable mount is opened from the fixed mount. Referring to FIGS. 1 and 2, according to the first embodiment of the present invention, the display device includes a fixed mount 1, a movable mount 2, a hinge 3, and an LCD module. As shown in FIG. 1, the fixed mount 1 and the movable mount 2 are jointly coupled with each other at least one side of the display device by at least one hinge 3. The LCD module is disposed between the fixed mount 1 and the movable mount 2. Referring to FIG. 2, the LCD module includes an LCD panel 4, an optical film stack 5 and a backlight source 6. The LCD panel 4, the optical film stack 5 and the backlight source 6 can be packaged as a whole and disposed inside the fixed mount 1 or the movable mount 2, or alternatively not packaged and individually disposed in the fixed mount 1 and the movable mount 2, respectively. In operation, the display device must be disposed to present the LCD panel toward the viewer. As such, a side where the LCD panel is positioned is defined as a front side of the display device, and other sides is thus defined in relative to the front side. As shown in FIG. 1, the movable mount 2 is positioned in front of the fixed mount 1, and is adapted for rotating relative to the fixed mount 1. When the movable mount 2 is rotated apart from the fixed mount 1, the movable mount 2 is defined as opened from the fixed mount 1, or otherwise when the movable mount 2 is maintained adjacent to the fixed mount 1, the movable mount 2 is defined as closed to the fixed mount 1. As shown in FIG. 1, it illustrates the status of the display device that the movable mount 2 is closed to the fixed mount 1. Preferably, a lock 21 can be provided for locking the movable mount 2 to the fixed mount 1, so that any unauthorized people without a key or a specific tool is prohibited from opening the movable mount 2 from the fixed mount 1. Alternatively, a latch structure which is not easy to open can also be used in substituting the lock 21.

According to another aspect of the embodiment, a pivot connection can be employed instead of the hinge 3 for jointly coupling the movable mount 2 with the fixed mount 1. In fact, any other connecting mechanism adapted for coupling the movable mount 2 with the fixed mount 1, and allowing the movable mount 2 to move or rotate relative to the fixed mount 1 can be employed for allowing the movable mount 2 to be opened or closed from the front side of the display device.

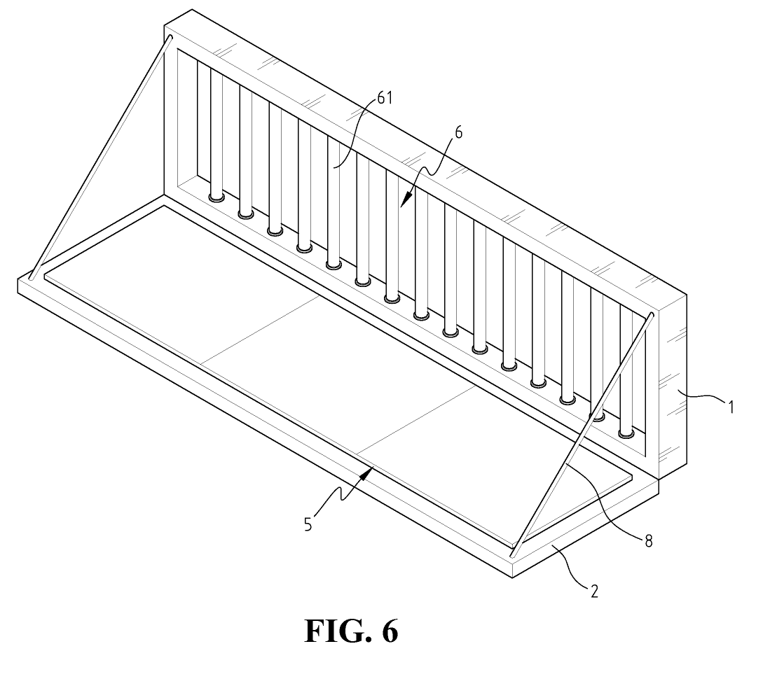

As shown in FIG. 6, the movable mount 2 is jointly coupled with the fixed mount 1 at the bottom side of the display device. According to an aspect of the embodiment, a connecting component 8 is provided for connecting the movable mount 2 with the fixed mount 1. The provision of the connecting component 8 provides an additional connection between the movable mount 2 and the fixed mount 1 when the movable mount 2 is opened from the fixed mount 1. The connecting component 8 for example can be a cord, a chain, or a rod piece, or an adjustable multi-section positioning structure (not shown in the drawings). Therefore, when the movable mount 2 is opened from the fixed mount 1, the connecting component 8, e.g., a cord or a rod piece pulls the movable mount 2 and holds it at a certain position with a desired angle, or alternatively a multi-section positioning structure is used to maintain the movable mount 2 at a desired angle relative to the fixed mount 1.

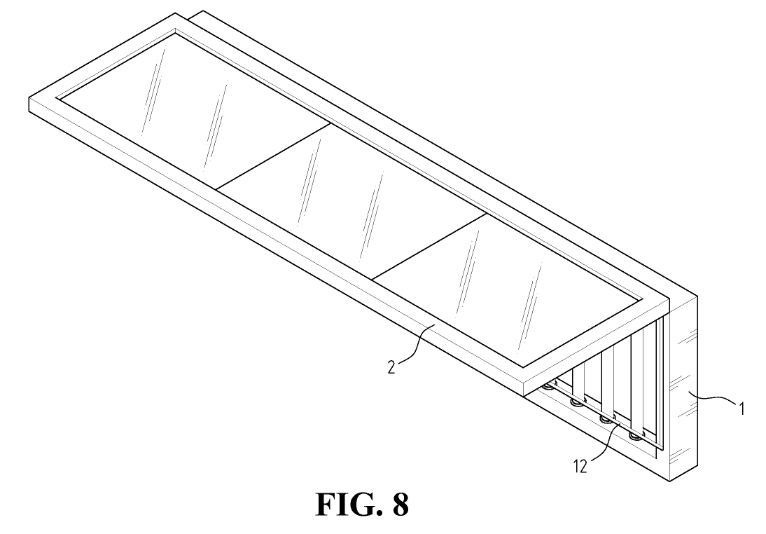

As shown in FIG. 8, according to an aspect of the embodiment, the movable mount 2 can also be jointly coupled with the fixed mount 1 at a top side of the display device. In accordance with this aspect, a supporting rod 12 can be provided at least one side of the fixed mount 1 and the movable mount 2. When the movable mount 2 is opened for maintenance, the supporting rod is used for supporting the movable mount 2 against the fixed mount 1, so as to maintain the movable mount 2 opened from the fixed mount 1 with a predetermined angle.

As shown in FIGS. 1 and 2, in this embodiment, the LCD module includes the LCD panel 4, the optical film stack 5 and the backlight source 6. The fixed mount 1 includes an inner space, in which the backlight source 6 is accommodated. The LCD panel 4 and the optical film stack 5 are disposed in the movable mount. Preferably, the backlight source 6 includes a plurality of lamp holders 62 symmetrically distributed at the top side and the bottom side of the fixed mount 1, respectively. Each pair of the lamp holder 62 is provided with a lamp tube 61. In such a way, a direct type backlight source is configured. Or, alternatively, the lamp holders 62 are symmetrically distributed at a left side and a right side of the fixed mount 1, respectively. Each pair of the lamp holder 62 is provided with a lamp tube 61. In such a way, a direct type backlight source is similarly configured. The movable mount 2 is configured with a hollow-out opening, so as to allow the LCD panel 4 and the optical film stack 5 disposed inside the movable mount 2 to present images from the hollow-out opening. When the movable mount 2 is closed to the fixed mount 1, and when the backlight source 6 is supplied with power to emit light, the light can be directly transmitted through the optical film stack 5 and the LCD panel 4.

When the display device needs to be maintained, the maintenance staff can open the movable mount 2 on site, and then conveniently disassemble the damaged part, e.g., optical film stack or lamp tube, and rapidly assemble a spare part back, and finally close the movable mount. Comparing with the conventional, the maintenance process is fast and convenient.

As mentioned above, the LCD module including the LCD panel, the optical film stack and the backlight source can be packaged as a whole, and assembled in an inner space of the fixed mount 1 and/or the movable mount 2.

Many kinds of light sources can be employed serving as the backlight source. For example, hot cathode fluorescent lamp (HCFL), cold cathode fluorescent lamp (CCFL), organic light emitting diode (OLED), or xenon lamp, or even sunlight can be selected. In other words, both artificial and natural light sources can be utilized in accordance with the present invention.

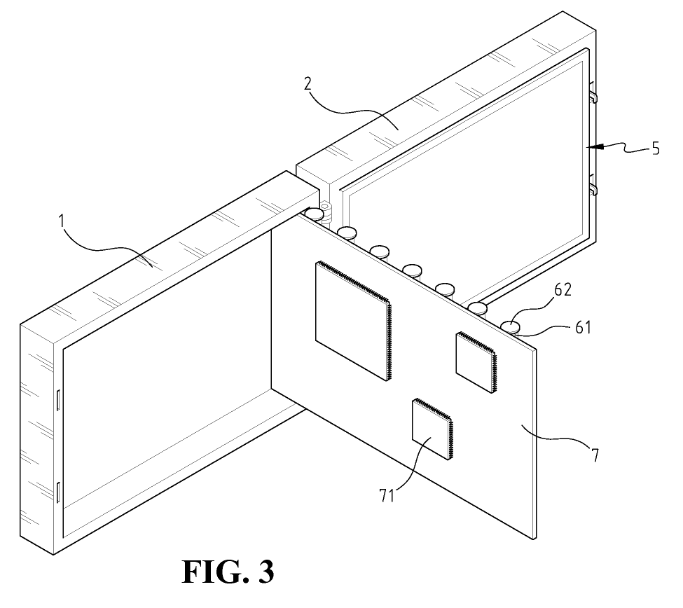

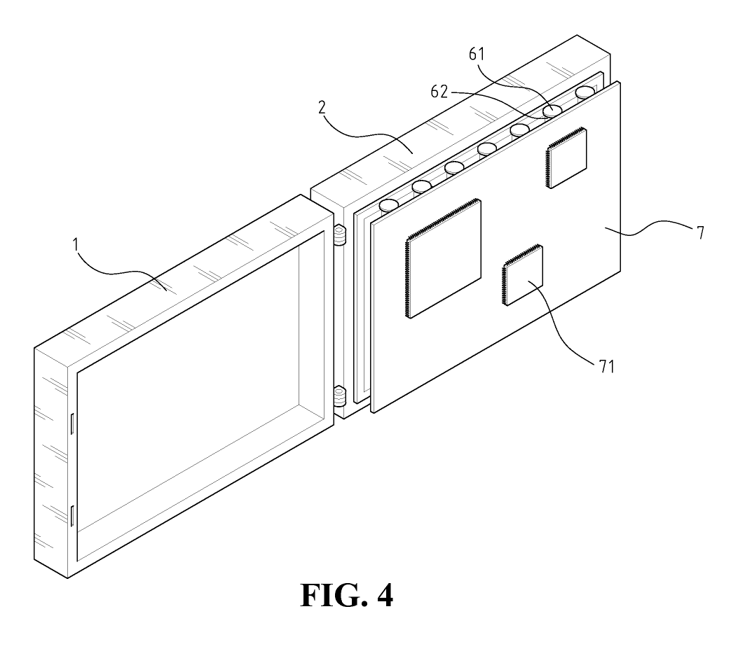

FIG. 3 illustrates a display device according to a second embodiment of the present invention, in which a movable mount and a substrate are shown as being rotated to open from the fixed mount. Referring to FIG. 3, and comparing with the first embodiment shown in FIGS. 1 and 2, the second embodiment of the present invention provides a display device further including a substrate 7 pivotally coupled to the fixed mount 1, and the backlight source 6 including the lamp holders 62 and the lamp tubes 61 is disposed on the substrate 7. The substrate 7 for example further includes a circuit board 71 disposed on a backside of the substrate. Similarly, when the display device needs to be maintained, the maintenance staff can open the movable mount 2 on site, and then conveniently turn the substrate 7 apart from the fixed mount 1 for disassembling the damaged part, e.g., optical film stack or lamp tube, and rapidly assemble a spare part back, and finally close the movable mount. Alternatively, with respect to the backlight source independent from the LCD panel and the optical film stack can also be directly disposed inside the movable mount 2 as shown in FIG. 4, which constitute the third embodiment of the present invention. In this case, when opening the movable mount, the backlight source 6 must be also turn over or disassembled for maintaining the optical film stack or the LCD panel.

FIG. 6 illustrates a fourth embodiment of the present invention. In accordance with the fourth embodiment, the display device has a large display area, and therefore, the display device includes a plurality of LCD panels assembled side-by-side to form a tiled display device. In a similar manner, the tiled display device of the fourth embodiment includes a fixed mount 1 and a movable mount 2. The fixed mount 1 and the movable mount 2 are defined with an inner space, in which a direct type backlight source 6 as illustrated above is disposed. Of course, other light sources such as hot cathode fluorescent lamp (HCFL), cold cathode fluorescent lamp (CCFL), organic light emitting diode (OLED), or xenon lamp, or even sunlight can also be used as a backlight source. The LCD panel 4 and the optical film stack 5 are disposed in the movable mount 2. As shown in FIG. 6, the movable mount 2 is jointly coupled with the fixed mount 1 at the bottom side of the display device. Specifically in the fourth embodiment, a connecting component 8 is provided for connecting the movable mount 2 with the fixed mount 1. The connecting component 8 for example can be a cord, a chain, or a rod piece, or an adjustable multi-section positioning structure (not shown in the drawings). Therefore, when the movable mount 2 is opened from the fixed mount 1, the connecting component 8, e.g., a cord or a rod piece pulls the movable mount 2 and holds it at a certain position with a desired angle, or alternatively a multi-section positioning structure is used to maintain the movable mount 2 at a desired angle relative to the fixed mount 1. In accordance with the fourth embodiment, when the movable mount 2 is closed to the fixed mount 1, and when the backlight source 6 is supplied with power to emit light, the light can be directly transmitted through the optical film stack 5 and the LCD panel 4.

When the display device needs to be maintained, the maintenance staff can open the movable mount 2 toward a specific direction on site, and then holds the movable mount at a horizontal plane or other predetermined angles relative to the fixed mount, so as to conveniently disassemble the damaged part, e.g., optical film stack or lamp tube, and rapidly assemble a spare part back, and finally close the movable mount.

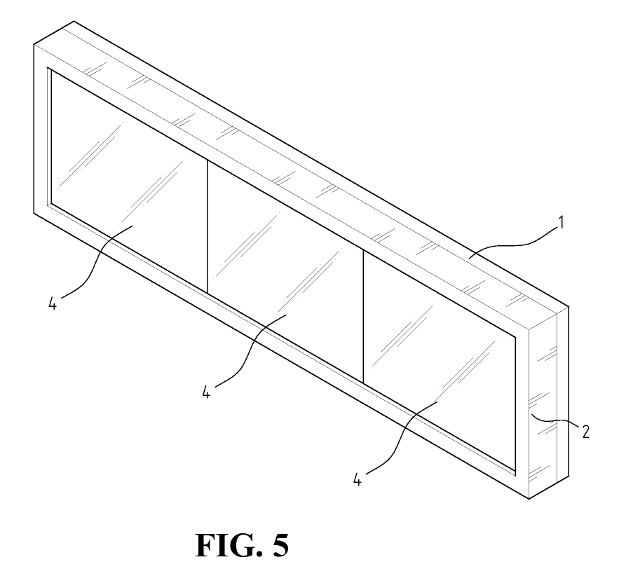

Referring to FIG. 5, according to another aspect of the fourth embodiment of the present invention, the movable mount 2 has an enlarged thickness so as to enable to be designed to have a larger internal space. Accordingly, the LCD panel 4, the optical film stack 5, and the backlight source 6 may be disposed in the movable mount 2. The fixed mount 1 having a smaller thickness only provides a fixation function on a wall.

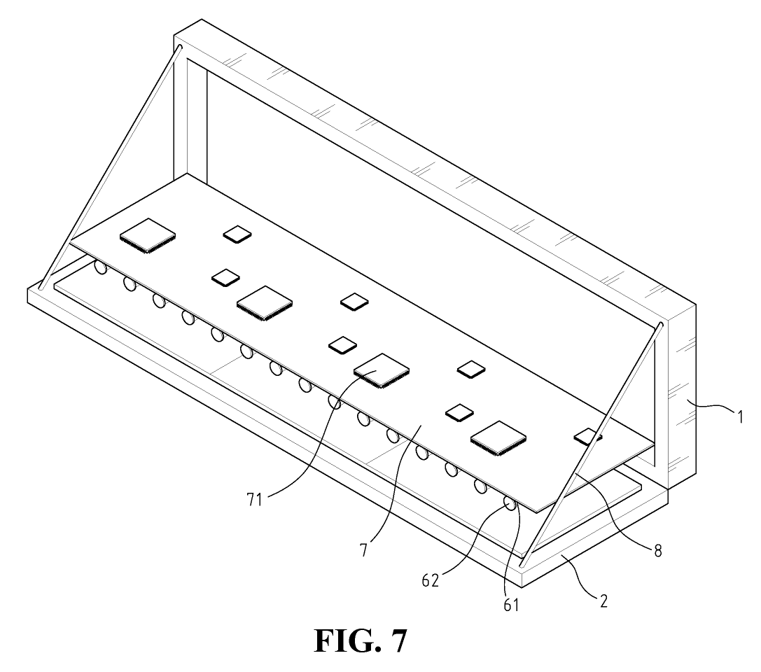

FIG. 7 illustrates a display device according to a fifth embodiment of the present invention, in which the movable mount and the substrate are opened from the fixed mount. The fifth embodiment as shown in FIG. 7 is a variation modified from the fourth embodiment. As shown in FIG. 7, relative to the fourth embodiment as discussed above, the fifth embodiment of the present invention provides a display device further including a substrate 7 pivotally coupled to the fixed mount 1, and the backlight source 6 including the lamp holders 62 and the lamp tubes 61 is disposed on the substrate 7. The substrate 7 for example further includes a circuit board 71 disposed on a backside of the substrate. Similarly, when the display device needs to be maintained, the maintenance staff can open the movable mount 2 on site, and then conveniently turn the substrate 7 apart from the fixed mount 1 for disassembling the damaged part, e.g., optical film stack or lamp tube, and rapidly assemble a spare part back, and finally close the movable mount.

As shown in FIG. 8, according to an aspect of the embodiment, the movable mount 2 can also be jointly coupled with the fixed mount 1 at a top side of the display device. In accordance with this aspect, a supporting rod 12 can be provided at least one side of the fixed mount 1 and the movable mount 2. When the movable mount 2 is opened for maintenance, the movable mount 2 is turned upwardly and then the supporting rod 12 is used for supporting the movable mount 2 against the fixed mount 1, so as to maintain the movable mount 2 opened from the fixed mount 1 with a predetermined angle.

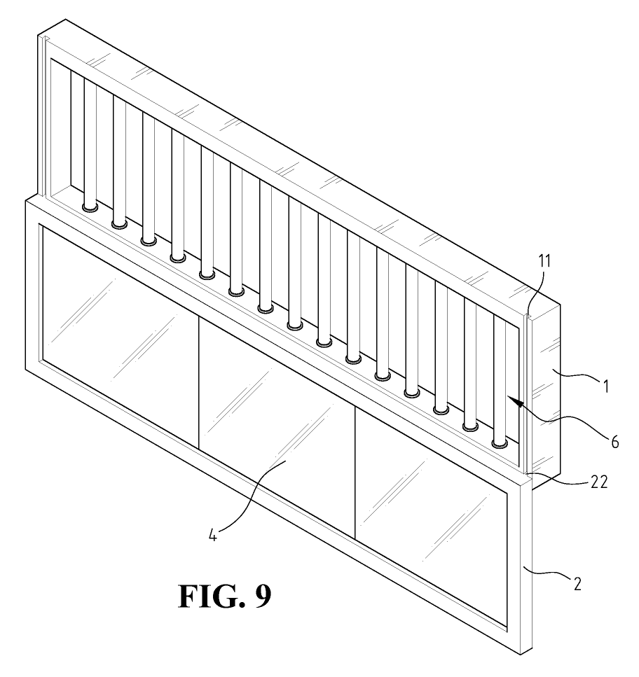

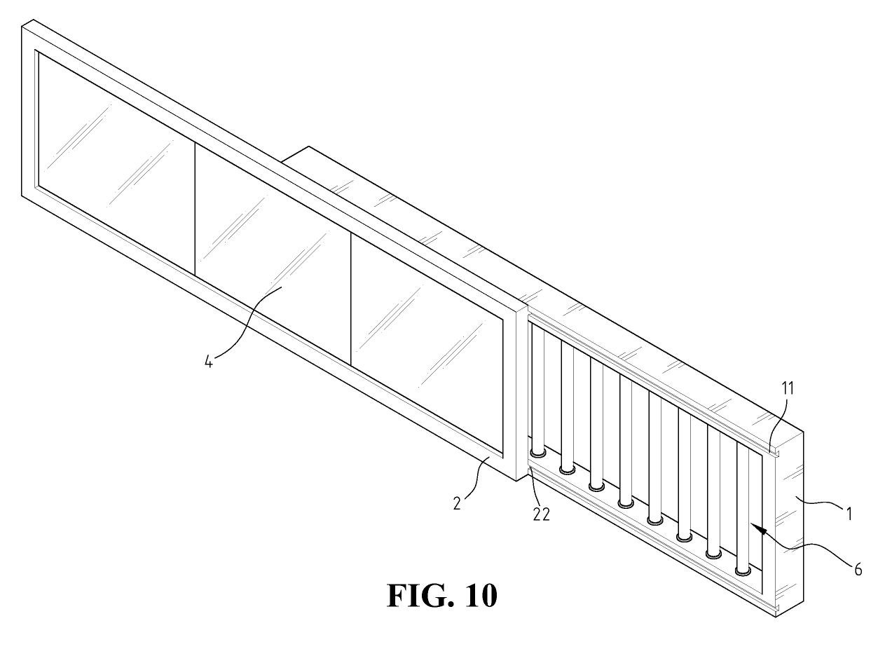

FIG. 9 illustrates a display device according to a seventh embodiment of the present invention, in which the movable mount and the fixed mount are vertically equipped with a set of guide rail and guide slot, respectively, so as to allow the movable mount to slide relative to the fixed mount along the guide slot. Referring to FIG. 9, at each of a left side and a right side of a front surface of the fixed mount 1, a vertical guide slot 11 is provided. Correspondingly, at each of a left side and a right side of a back surface of the movable mount 2, a guide rail 22 is provided. The guide rails 22 and the guide slots 11 are slidably coupled one to another. When the display device needs to be maintained, the maintenance staff can open the movable mount 2 on site by sliding the movable mount 2 upwardly or downwardly relative to the fixed mount 1, and then conveniently disassemble the damaged part, e.g., optical film stack or lamp tube, and rapidly assemble a spare part back, and finally close the movable mount. Alternatively, in accordance with another aspect of the embodiment, the positions of the guide rails 22 and guide slots 11 can be exchanged, in that the guide rails 22 are disposed on the fixed mount 1, and the guide slots 11 are disposed on the movable mount 2. Further, as shown in FIG. 9, the guide rails 22 and the guide slots 11 are disposed along a vertical direction. However, as shown in FIG. 10, the eighth embodiment is a variation modified from the seventh embodiment, in which the guide rails 22 and the guide slots 11 are disposed along a horizontal direction. In accordance with the seventh embodiment and the eighth embodiment, when the movable mount 2 is opened from the fixed mount 1, the optical film stack 5 is positioned behind the movable mount 2, and therefore the seventh embodiment and the eighth embodiment are more suitable for installing in a large site, so as to allow the maintenance staff to work at the back side of the movable mount 2.

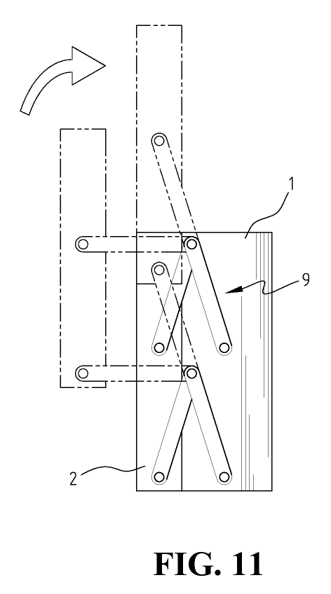

FIG. 11 illustrates a display device according to a ninth embodiment of the present invention. Referring to FIG. 11, a connecting rod set 9 is provided at least one lateral side of the fixed mount 1 and the movable mount 2 for allowing the movable mount 2 to be laterally opened and closed relative to the fixed mount 1 thereby.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A liquid crystal display (LCD) device, comprising:
a fixed mount;
a movable mount, movably coupled to the fixed mount, wherein the movable mount is operably closed or opened relative to the fixed mount from a front side of the LCD device, and the movable mount comprises a hollow-out opening; and
an LCD module, disposed in an inner space defined by the movable mount and/or the fixed mount, wherein the LCD module is adapted for presenting images from the hollow-out opening.

2. The LCD device according to claim 1, wherein the LCD module comprises an LCD panel, an optical film stack, and a backlight source, and the LCD panel is disposed in a position in the movable mount corresponding to the hollow-out opening, the optical film stack is disposed in a back side of the LCD panel, the backlight source is disposed in movable mount and/or the fixed mount.

3. The LCD device according to claim 1, wherein the movable mount is movably coupled with the fixed mount at one side of the LCD device by at least one hinge or pivot.

4. The LCD device according to claim 2, wherein the backlight source includes a plurality of lamp holders symmetrically distributed at a top side and a bottom side of the fixed mount or the movable mount, and each pair of the lamp holder is adapted for holding a lamp tube.

5. The LCD device according to claim 2, wherein the backlight source comprises a plurality of lamp holders symmetrically distributed at a left side and a right side of the fixed mount or the movable mount, and each pair of the lamp holder is adapted for holding a lamp tube.

6. The LCD device according to claim 2, wherein a substrate is pivotally coupled to one side of the movable mount or the fixed mount, and the backlight source is disposed on the substrate.

7. The LCD device according to claim 6, wherein the backlight source comprises a plurality of lamp holders symmetrically distributed at a top side and a bottom side respectively, or a left side and a right side respectively of the fixed mount or the movable mount, and each pair of the lamp holder is adapted for holding a lamp tube.

8. The LCD device according to claim 1, wherein the movable mount is movably coupled with the fixed mount at one side of the LCD device by at least one connecting component.

9. The LCD device according to claim 8, wherein the connecting component is a cord, a chain, a rod piece, or a multi-section positioning structure.

10. The LCD device according to claim 1, wherein the movable mount and the fixed mount are provided with a set of guide rail and guide slot, respectively, at a vertical direction or a horizontal direction, so as to allow the movable mount to slide relative to the fixed mount along the guide slot.

11. The LCD device according to claim 1, wherein a connecting rod set is provided at least one lateral side of the fixed mount and the movable mount for allowing the movable mount to be laterally opened or closed relative to the fixed mount.
